(19) United States
(12) Patent Application Publication
(10) Pub. No.: US 2021/0170640 A1
(43) Pub. Date: Jun. 10, 2021

(54) METHOD FOR MAKING A THREE-DIMENSIONAL OBJECT

(71) Applicant: Zoinks Ltd., Pawtucket, RI (US)

(72) Inventor: Dejiayong Tsai, Shantou City (CN)

(73) Assignee: Zoinks Ltd., Pawtucket, RI (US)

(21) Appl. No.: 16/870,828

(22) Filed: May 8, 2020

Related U.S. Application Data
(60) Provisional application No. 62/943,524, filed on Dec. 4, 2019.

(51) Int. Cl. B29C 39/02; A63H 33/00; B29C 39/36; B29C 39/24

(52) U.S. Cl. CPC B29C 39/02; A63H 33/001; A63H 9/00; B29C 39/24; B29C 39/36

(57) ABSTRACT

A method, composition and kit that enable the creation of a three-dimensional object by the action of placing at least one molding composition of at least one color or type into a mold, and then subsequently placing the mold within a liquid hardening agent to cure and solidify the molding composition enough so the three-dimensional object can be removed from the mold and become an object of display or a toy to be played with.

### CROSS-REFERENCE TO RELATED APPLICATIONS

This application claims priority based on U.S. Provisional Application No. 62/744,642 filed Oct. 11, 2018 and U.S. Provisional Application No. 62/943,524 filed Dec. 4, 2019.

### FIELD OF THE INVENTION

The invention is in the field of molding methods and compositions, more specifically molding a composition to form toys, including figurines, including the field of user-creatable toys using materials provided in a kit.

### BACKGROUND OF THE INVENTION

There are countless DIY (do-it-yourself) sets available today, everything from make your own jewelry to make your own bath bombs. Some popular sets from the past that are still around today include Shrinky Dinks®, Easy-Bake® Ovens and Creepy Crawlers®. There were many different Creepy Crawler sets available, but many of them involved insects and worms. They could be made by pouring some liquid (affectionately called slime) into a mold and popping it into a specially provided mini-oven. Once cooked, it was always a challenge to separate the new rubbery Creepy Crawler creation from the mold without losing any of its legs in the process.

The method of the present invention can also use molds, but the composition being molded can be made thick enough, or rather sufficiently viscous, so that it can be molded into any shape in a user's imagination on a molding surface, as opposed to using a depression or space within a mold which has a fixed shape. Also, the inventive method uses an entirely new method involving a liquid-based curing solution to cure or harden the toy being created; it doesn't “cook” it in a mini-oven.

### SUMMARY OF THE INVENTION

The general object of the inventive method is to make a floppy, jiggly, squishy fun three-dimensional object or toy.

In one embodiment, the method of the invention comprises:

applying at least one molding composition (e.g., a molding composition, a gel, different colors, textures, sparkles, glitter, glow in the dark, scented, color change, eraser properties, etc.) to a mold and/or molding surface, usually several different molding compositions are used in one mold or layered on a molding surface, also, one molding composition can be layered on another to make decorations or eye balls, etc.;

providing a curing/hardening solution, or first adding a curing activator/hardener to liquid to create a curing solution, the liquid usually includes water or is water;

immersing the composition into the curing solution (or immersing the composition and the mold and/or molding surface) (for a pre-determined amount of time, usually the composition starts to cure within 1 to 3 seconds, but may take up to 10 to 15 seconds or more);

curing the composition in the curing solution for a pre-determined amount of time, the curing can be continued by leaving the molded composition in the curing solution after it is released from the mold;

forming from the cured composition a three-dimensional object or toy;

and then, if it hasn't been done so already, removing the three-dimensional object from the mold and/or molding surface; the molded form begins to cure/harden and shrink away from the mold within about 1 to about 3 seconds after being immersed in the curing solution, then complete release of the molded object is encouraged by shaking the mold and/or molding surface, but it will usually release on its own without shaking. Gentle shaking is preferred. Then, the same curing solution can be used to make another three-dimensional object. Even though the molded composition form gets harder, and shrinks away from the edges of the mold, at the same time it puffs up and actually gets thicker, more rounded in shape. The result of the curing process is a thickened outer membrane and the longer the three-dimensional object is cured, the harder it gets on the inside. On the other hand, it's fun to play with it soon after it's made, when it's first cured. At that point, you can squeeze it and squish out its contents.

In another embodiment, the invention is a molding composition comprising: 85 to 95% water, with a tolerance of +/−X % of the mass of this component; 1 to 5% of sodium alginate, with a tolerance of +/−X % of the mass of this component; 0.95 to 1.5% of hydroxypropylmethyl cellulose, with a tolerance of +/−X % of the mass of this component; and 0.005 to 0.05% of trisodium 1-(1naphthylazo)-2-hydroxynaphthalene-4′,6,8-trisulphonate, with a tolerance of +/−X % of the mass of this component.

In yet another embodiment, the invention is a molding kit for molding at least one three-dimensional object comprising:

at least one molding composition, at least one of the at least one molding compositions comprising water, at least one first thickener, at least one second thickener and at least one red dye, the kit can include molding compositions of different colors, or some solid/opaque colors and some translucent colors, or a clear colorless molding composition, or a molding composition with glitter or one that glows in the dark, etc.;

at least one curing agent; and

at least one mold and/or molding surface, the molds can come in all different shapes and sizes, popular ones include starfish, octopi, dolphins, clams, aliens, penguins, sharks, fish, mermaids, etc.

### BRIEF DESCRIPTION OF THE DRAWINGS

FIG. 1 shows bottles containing different colors of the composition used in a method of the claimed invention;

FIG. 2A shows an example of a mold for use in a method of the claimed invention;

FIG. 2B shows a representative cross-section of an exemplary mold for use in a method of the claimed invention;

FIG. 3A shows a container provided with water in accordance with a method of the claimed invention, into which container a curing agent and later the molding composition and/or molding composition still in the mold can be placed;

FIG. 3B shows a package containing a curing or hardening agent which can be added to the water in the container of FIG. 3A in accordance with a method of the claimed invention;

FIG. 4A shows a first color molding composition being dispensed within a mold in accordance with a method of the claimed invention;

FIG. 4B shows a second color molding composition being applied to the same mold of FIG. 4A in accordance with a method of the claimed invention;

FIG. 5 shows the locations of four different colors of molding composition which were applied to the mold of FIG. 4A in accordance with a method of the claimed invention;

FIG. 6 show shows the filled mold of FIG. 5 being fully immersed within a curing solution in accordance with a method of the claimed invention;

FIG. 7 shows a free form application of molding composition to form layers of molding composition applied to a surface in accordance with a method of the claimed invention;

FIG. 8 shows a figurine which has been imbedded with magnetic material, in accordance with a method of the claimed invention, to enable magnetic attachment of the figurine to a pin that attaches to clothing or fabric to create a wearable user-created figurine;

FIG. 9 is an example of one embodiment of a special effects module that can be placed into and molded within a figurine, in accordance with a method of the claimed invention, the special effects module can produce lighting patterns or audio patterns;

FIG. 10A shows one embodiment of a one-arm mechanism that can be placed into and molded within a figurine, in accordance with a method of the claimed invention, this one-arm mechanism having an arm that moves between two positions and being able to impart motion to the figurine so that one portion of the figurine can move relative to another portion of the figurine;

FIG. 10B shows one embodiment of a two-arm mechanism that can be placed into and molded within a figurine, in accordance with a method of the claimed invention, this mechanism having two arms that moves between two positions to impart motion to the figurine so that two portions of the figurine can move relative to at least one other portion of the figurine.

FIG. 11 shows another special effects module;

FIG. 12 shows bottles of different colored molding compositions and several different molds;

FIG. 13 shows a user beginning to dispense composition of a third color into a mold which already has composition in two other colors, in accordance with a method of the invention;

FIG. 14 shows a user dispensing composition of a fourth color into a mold which already has composition in three other colors, specifically, the user is filling in the legs of the creature mold of FIG. 13, in accordance with a method of the invention;

FIG. 15 shows a user having just finished layering one color molding composition for the eyes over the color molding composition for the remainder of the head, to finish the application of composition into the mold shown in FIG. 13;

FIG. 16 shows a user immersing in water the composition filled mold created in FIGS. 13-15, in accordance with a method of the invention;

FIG. 17 shows a user beginning to shake the mold and the newly made toy beginning to release from the mold, in accordance with a method of the invention; and

FIG. 18 shows marketing material for commercial sale of a method of the invention;

FIG. 19 shows two different colored molding compositions filling a dolphin mold;

FIG. 20 shows another view of the dolphin mold of FIG. 19;

FIG. 21A shows a previously made dolphin from the mold of FIG. 19;

FIG. 21B shows another view of the dolphin mold of FIG. 19;

FIG. 22 shows another view of the dolphin mold of FIG. 19;

FIG. 23 shows the molded dolphin form starting to shrink away from the sides of the mold as it cures and as the mold is shaken;

FIG. 24 shows the cured, finished dolphin in the mold, now much smaller in overall size than the mold, but thicker than the mold;

FIG. 25 shows the cured, finished dolphin in the mold, now much smaller in overall size than the mold, but thicker than the mold; and

FIG. 26 shows the cured, finished dolphin being held.

### DETAILED DESCRIPTION OF THE INVENTION

The following definitions are used for the terms described herein:

### Definitions

Gel—a thick semi-liquid, semi-solid substance that is viscous, but cannot be picked up without it breaking apart. This is in contrast with the solid three-dimensional object resulting from the methods of the invention, or from using the inventive compositions or using the inventive kit, that solid three-dimensional object is a solid and it can be picked up without breaking apart. However, depending on the level of cure of the solid three-dimensional object, how hard it is, it can contain one or more layers of gel inside of varying levels of hardness (solid-ness).

The following is a list of components identified in the figures:

### COMPONENTS

1 representative bottle
1A gel of color C1
1B gel of color C2
1C gel of color C3
1D gel of color C4
2 gel entering mold
3 gel exiting nozzle forming a layer
5 nozzle
10 depression in which a figurine is molded
11 mold
12 hardening agent
13 water
14 container
15 mixture of water and hardening agent
20 uncured object
21 three-dimensional figurine with imbedded metal
22 metal disk of magnetic material
23 magnet
24 pin
25 attachment clasp
26 garment fabric
30 surface
48 general system components for a special effects module
49 generalized mechanism
50 special effects module
51 LEDs
52 audio output
53 at least one battery
54 electronics
55 magnetic reed switch trigger
56 coil
57 ball or motion switch
58 communications subsystem
59 magnet
60 one-arm mechanism
61A arm in position A
61B arm in position B
62 one-arm mechanism body
70 two-arm mechanism
71A left arm in position A
71B left arm in position B
72A right arm in position A
72B right arm in position B
73 two-arm mechanism body
90 bottle of gel
91 mold(s)
93 water
95 mold filled with gel(s)

The invention is explained in further detail with reference to the figures, examples and embodiments below.

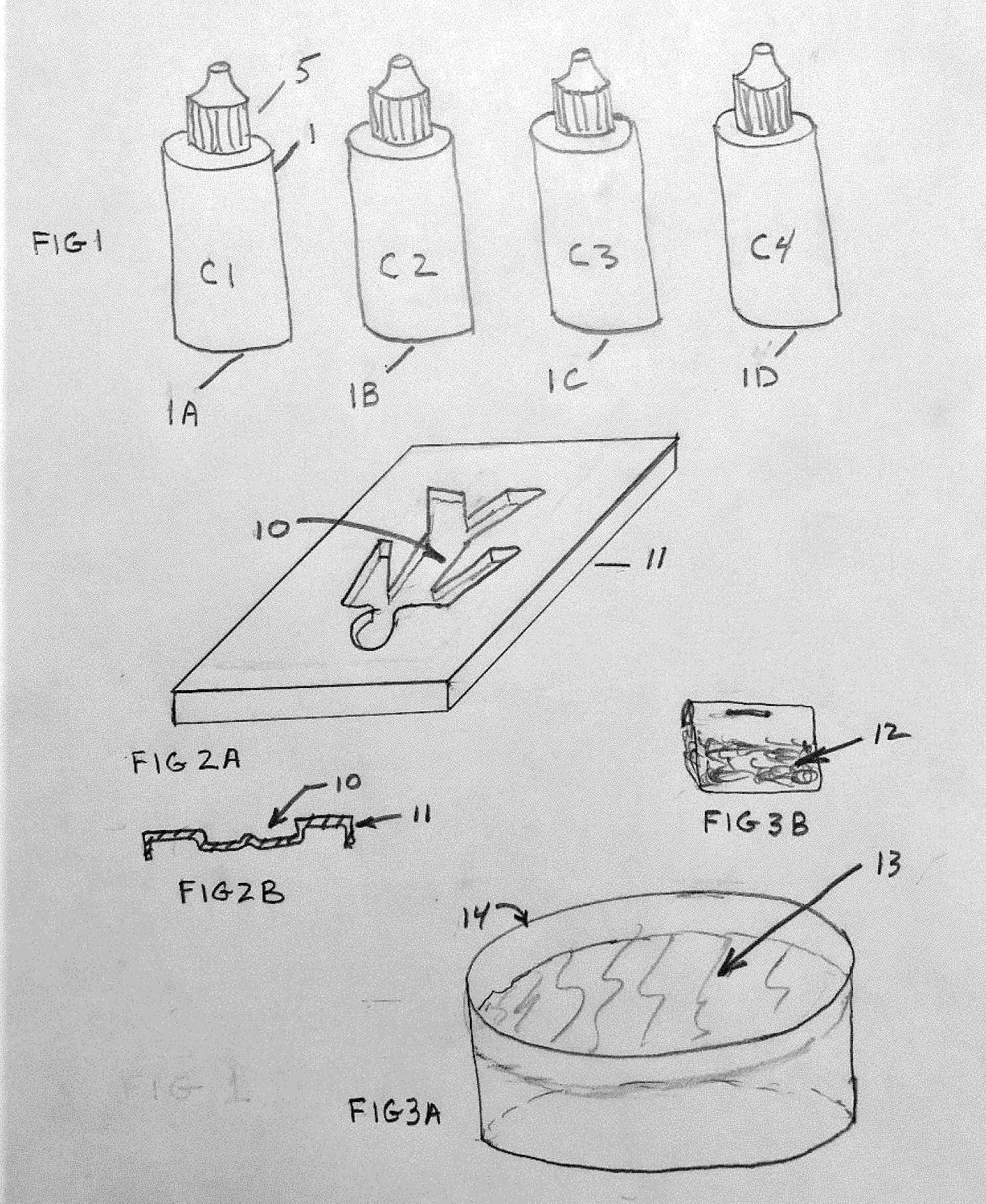

FIG. 1 shows examples of four bottles containing four different color molding compositions. Each representative bottle 1 has a nozzle 5 from which the molding composition exits the interior of the representative bottle 1. Shown is bottle 1A containing color C1, bottle 1B containing color C2, bottle 1C containing color C3, and bottle 1D containing color C4. Each representative bottle shown is a squeeze bottle which must normally be squeezed, usually by applying pressure to the sides of the bottle, to dispense the contents thereof. However, the composition used in the method of the invention can be dispensed from any sort of container, for example, a bottle that does not have to be squeezed, but which pours out the composition, or a bottle which has a pumping mechanism to dispense the composition, or a tube which can be squeezed to dispense the composition, etc.

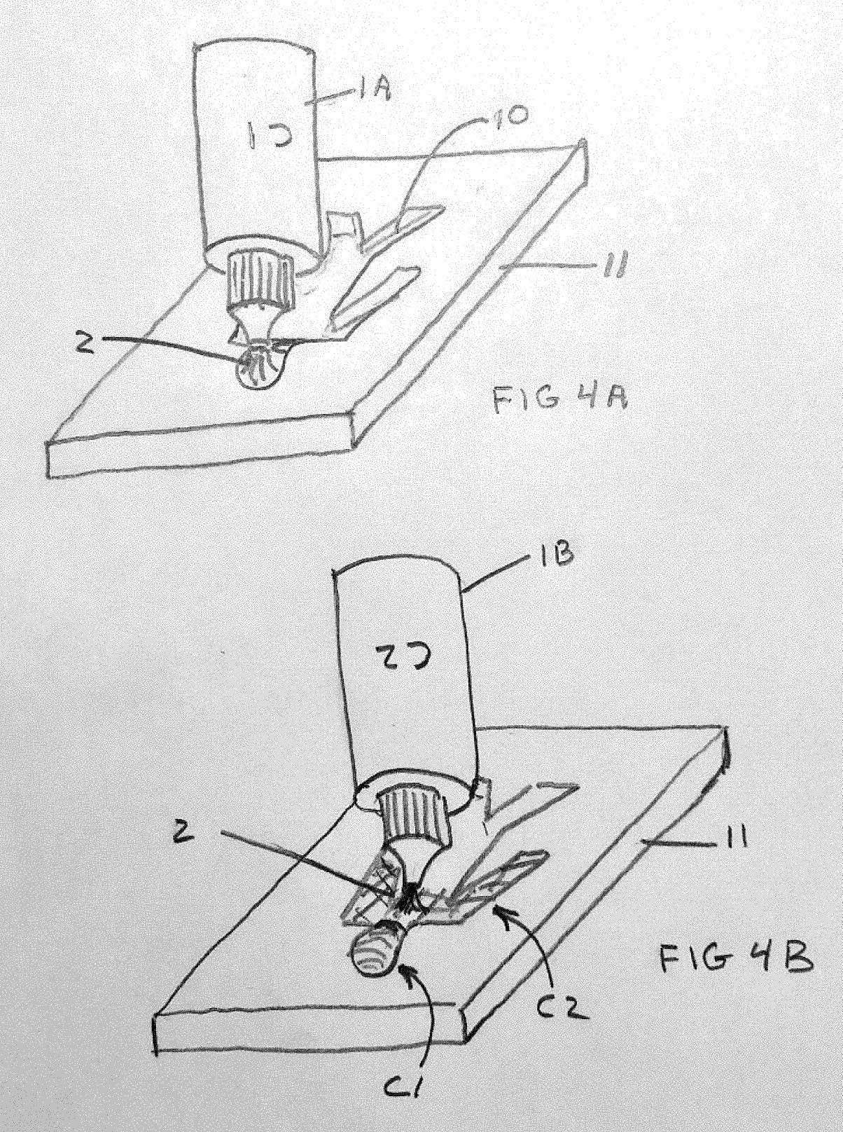

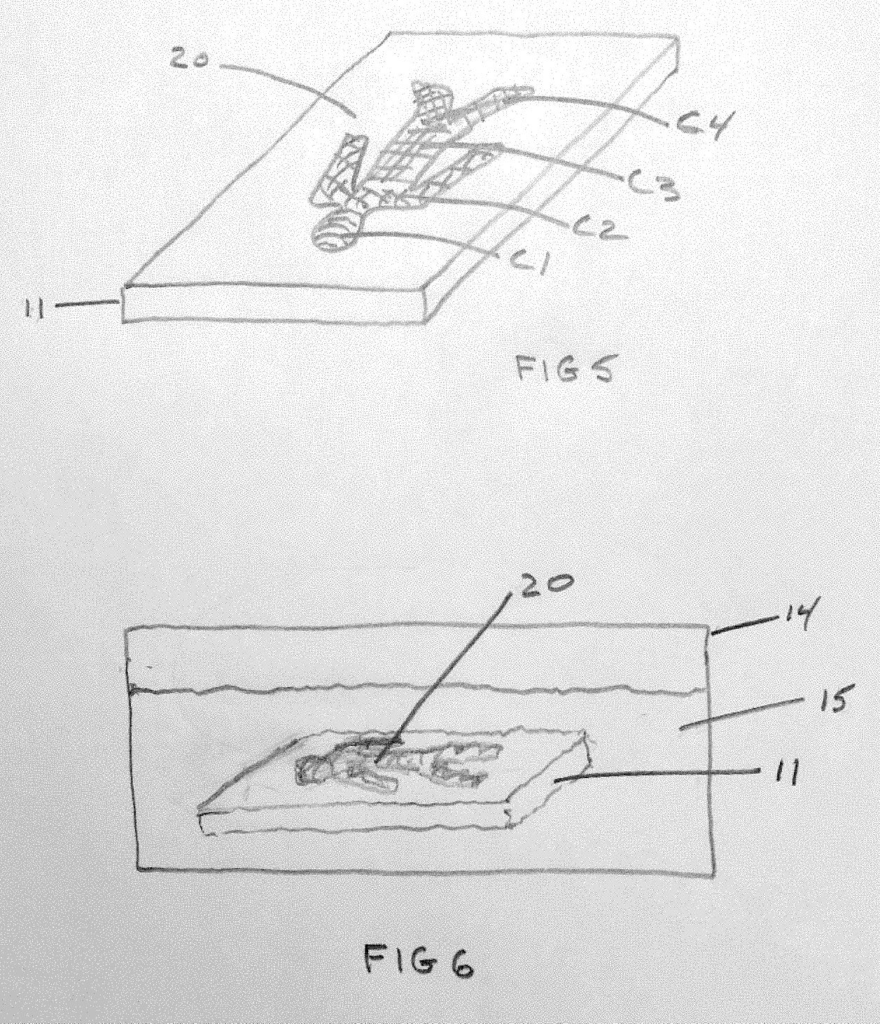

FIG. 2A shows a typical mold 11 and a depression 10 which is filled with composition during the method to create a three-dimensional object, toy, a figurine, etc. The molded shape can be any fun shape the imagination desires, since it can either be made using a mold or by free-hand on a molding surface, in accordance with the inventive method. A single color molding composition can be applied or any number of different colored compositions or different types and textures.

FIG. 2B shows a representative cross-section of mold 11 where molding composition can be applied within a depression 10 in which a figurine is molded. This depression 10 forms a cavity contained at the bottom of the mold so the molding composition is contained by gravity and thus does not spill out while handling.

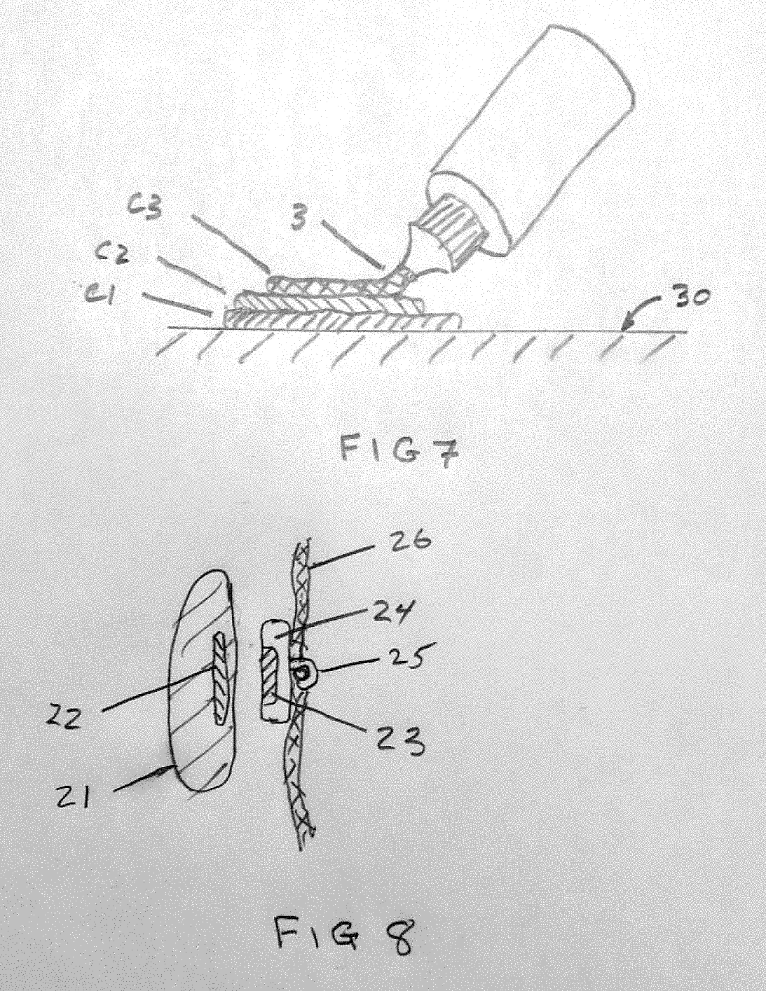

FIG. 3A shows a container 14 filled with water 13 in which the molding composition in the mold 11 (the molded composition form) or on a molding surface (the molded composition form) can be placed after water 13 is mixed with hardening agent 12 to create the curing solution.

FIG. 3B shows a package containing the hardening agent 12.

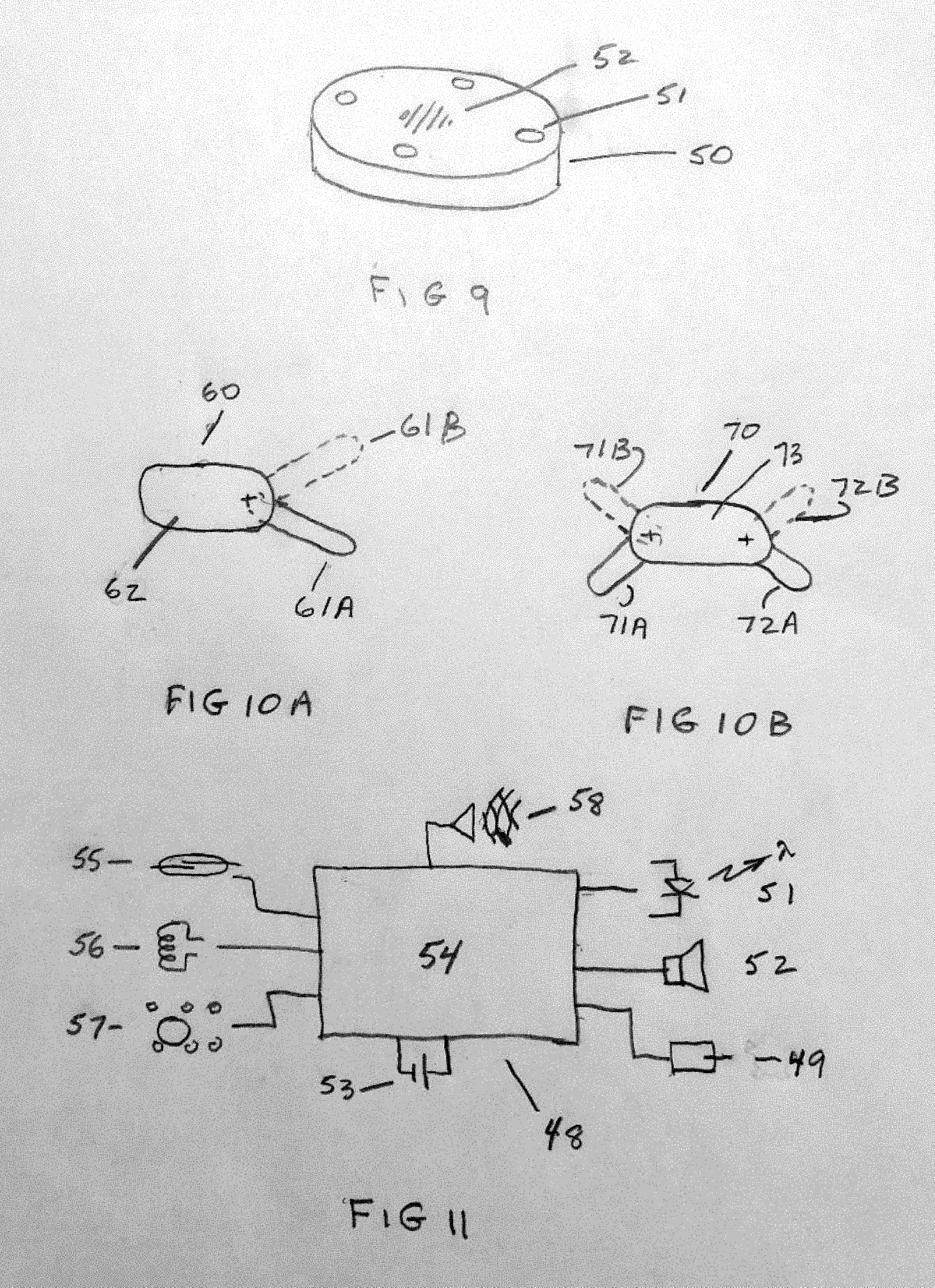

FIG. 4A shows molding composition 2 entering mold 11 coming from representative bottle 1A of color C1. The molding composition 2 entering mold 11 is filling depression 10 in which a figurine is being molded.

FIG. 4B shows a second color molding composition being applied to the same mold of FIG. 4A. Shown is molding composition 2 entering mold 11 coming from representative bottle 1B of color C2. Already present is the molding composition of color C1, applied in FIG. 4A, occupying one portion of the depression 10 in which a figurine is molded.

FIG. 5 shows the completion of dispensing steps of four colors of molding compositions, C1, C2, C3, and C4, to fill mold 11 and create the uncured object 20 (the molded composition form) within mold 11.

FIG. 6 shows immersing in a curing solution 15, the mold 11 containing the uncured object 20 of FIG. 5, which is fully immersed within a mixture of water and hardening agent, the curing solution 15, contained within container 14.

In one example of the method of the invention, the curing solution 15 is formed by placing approximately 1 gram of hardening agent 12 within about 100 milliliters of water 13. 100 milliliters of water is approximately equal to about 100 grams of water 13 which occupies approximately 100 cubic centimeters (CCs) of volume, where water has the approximate density of 1 gram per CC. In another example of the method of the invention, the curing solution is formed by placing approximately 5 grams curing agent in about 250 ml water, H₂O and/or a water-like (a liquid) substance (referred to herein as “water”).

The range of the amount of curing and/or hardening agent and water to make the solution depends upon a number of factors, including the size of the molded object being made, the number being made using that batch of curing/hardening solution, the degree of curing/hardening desired, whether the user intends to keep the three-dimensional object made by the method or squish out its contents, etc. These ranges are useful guides for practicing the inventive method: for example, about 0.25 g curing/hardening agent to about 400 ml water, about 0.5 g curing/hardening agent to about 350 ml water, about 1 g curing/hardening agent to about 300 ml water, about 1 g curing/hardening agent to about 250 ml water, about 1 g curing/hardening agent to about 250 ml water, about 1.5 g curing/hardening agent to about 200 ml water, about 2 g curing/hardening agent to about 150 ml water, about 2.5 g curing/hardening agent to about 100 ml water, about 1 g curing/hardening agent to about 100 ml water, about 3 g curing/hardening agent to about 50 ml water, about 6 g curing/hardening agent to about 300 ml water, about 5.5 g curing/hardening agent to about 250 ml water, about 5 g curing/hardening agent to about 250 ml water, about 4.5 g curing/hardening agent to about 200 ml water, about 4 g curing/hardening agent to about 150 ml water, about 3.5 g curing/hardening agent to about 100 ml water, and about 3 g curing/hardening agent to about 50 ml water.

FIG. 7 shows the free form application of molding compositions to form layers of molding compositions applied to molding surface 30. Shown is molding composition exiting nozzle forming a layer 3 which is molding composition of color C3 which is being applied on top of molding composition of color C2. In FIG. 7, molding composition of color C2 has already been applied on top of molding composition of color C3, and molding composition of color C3 has been applied to surface 30.

FIG. 8 shows an example of a finished three-dimensional figurine 21 made by the inventive method with an imbedded metal disk of magnetic material 22 to enable magnetic attachment to magnet 23 of pin 24 that attaches via an attachment clasp 25 to garment fabric 26 (some type of clothing) to create a wearable user-created figurine. It should be noted that the magnet can be in the figurine and the magnetic metal can be the pin itself or attached to the pin, as shown, so as long as there is one magnet and one magnetic metal disk the wearable figurine can be magnetically attached without deviating from the spirit of the invention.

FIG. 9 is an example of one embodiment of a special effects module 50 that can be placed and molded within a three-dimensional figurine in accordance with the inventive method. The special effects module 50 can be waterproof or water resistant so it can be immersed within the molding composition, the curing/hardening solution or the plain water once the figurine is made, and remain functional. The special effects module 50 can either produce only lighting patterns produced by LEDs 51 or only audio patterns and sounds from the audio output 52, or both. These types of modules are generally known in the art. Some of them operate to emit sound and/or light when squeezed, or when the object they are contained in hits another surface, or when triggered by remote control, etc. The waterproof special effects module 50 can also be gasketed so as to be immersible in water or molding composition.

FIG. 10A shows one embodiment of a magnetic reactive metal (a metal that responds to a magnet) one-arm mechanism 60 with an arm that moves between two positions, 61A and 61B. In one embodiment of the invention, this mechanism could be imbedded within a figurine to impart motion to the figurine so that one portion of the figurine can move relative to another portion of the figurine by using a magnet to move it. In this drawing is shown the one-arm mechanism body 62, and attached thereto is an arm in position A, 61A and the same arm in position B, 61B, both positions relative to the one-arm mechanism body 62. The one-arm mechanism 60 can be gasketed so as to be immersible in water or molding composition. The motion demonstrated in this embodiment is only one type of motion shown for example only, but there can be other types of motion that can be generated and remain within the spirit of this invention, which is to impart motion to the figurine. The motion can have translational and rotational components and is not limited to one kind of motion. Also, the special effects module 50 of FIG. 9 can be incorporated along with the one-arm mechanism 60 so that motion and lights and sound can all be part of a total special effect.

FIG. 10B shows one embodiment of a magnetic reactive metal (a metal that responds to a magnet) two-arm mechanism 70 with two arms that move between two positions. This mechanism could be imbedded within a figurine to impart motion to the figurine so that two portions of the figurine can move relative to at least one other portion of the figurine. In this drawing is shown a two-arm mechanism body 70 with a left arm in position A, 71A and the same arm in left arm position B, 71B, both positions relative to the two-arm mechanism body 73. Also shown is a right arm in position A, 72A and the same arm in right arm position B, 72B, both positions relative to the two-arm mechanism body 73. The two-arm mechanism 70 can be gasketed so as to be easily immersible in water or molding composition. The motion demonstrated in this embodiment is only one type of motion shown for example only, but as stated, there can be other types of motion that can be generated and remain within the spirit of this invention, which is to imbed a motion generating mechanism within a figurine to impart motion to the figurine. The motion can have translational and rotational components and is not limited to one kind of motion. Also, everything incorporated within the special effects module 50 of FIG. 9 could be incorporated within the two-arm mechanism 70 so that motion and lights and sound can all be part of a total special effect. In each of 10 A and 10 B the arms can be moved by the user holding an external magnet and waving it over the figurine at the place where the arms are embedded.

FIG. 11 shows another embodiment of a special effects module 48. Shown are electronics 54 and battery 53 to power the electronics. As an output the general system components for the special effects module 48 show display LEDs 51, an audio output 52, and a generalized mechanism 49. Depending on the product, the general system components for a special effects module 48 can contain any components listed either individually or in different combinations.

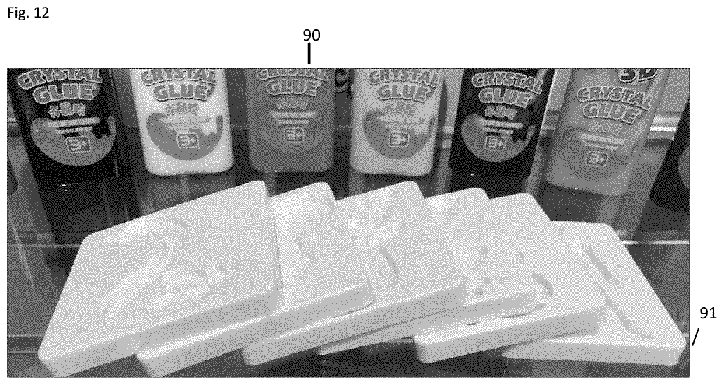

FIG. 12: Depicts bottles 90 labeled “Crystal Glue” which are bottles of the molding composition, which is also called gel or glue, that make up the inside gel portion of the invention, and are squeezed out or poured into molds 91 which are also depicted in this photograph, then the completed gel creation with the mold will be immersed or submerged into a mixture comprising the powdered portion of the invention formula (the hardener or curing agent) and water or other liquid at which point immediately the creation reacts with the liquid mixture and hardens into a final three dimensional (3D) object, creation, toy, figure, figurine, and/or thing.

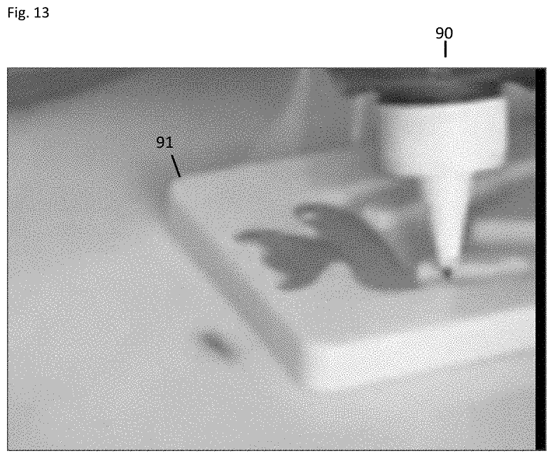

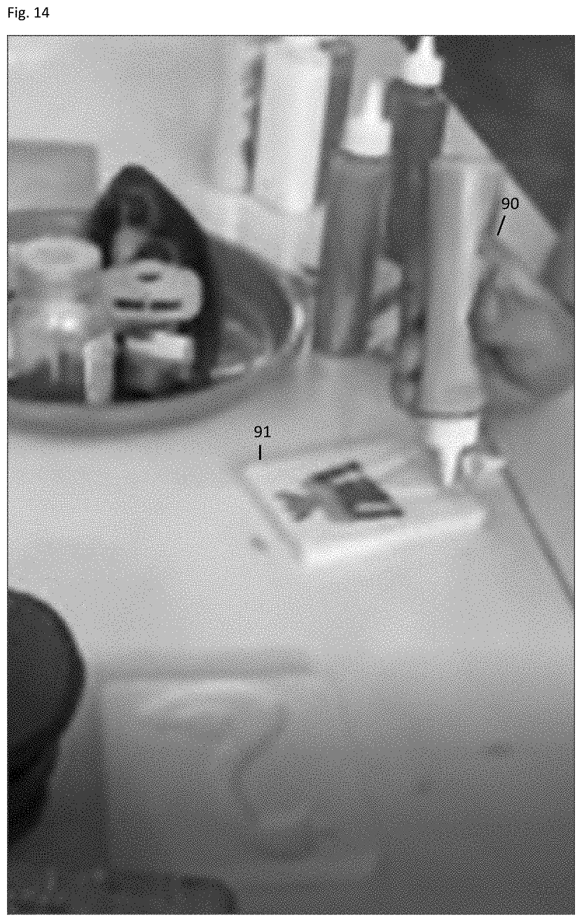

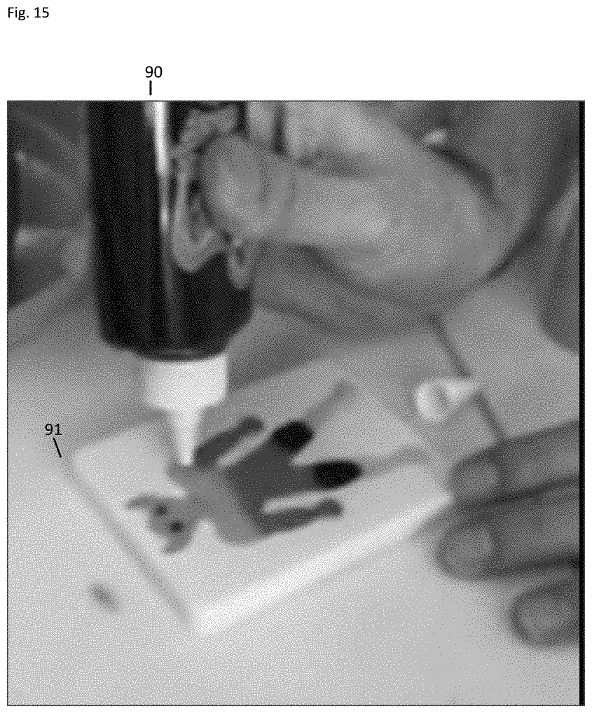

FIGS. 13-15: Depict a user dispensing, or in this case squeezing, a squeeze bottle 90 containing the molding composition portion used in the invention into mold 91 and designing an object or creation of choice using (squeezing or dispensing) different colored molding compositions in one mold 91 which will create a unique 3D sculpture, object, solid object, or design once the process is completed.

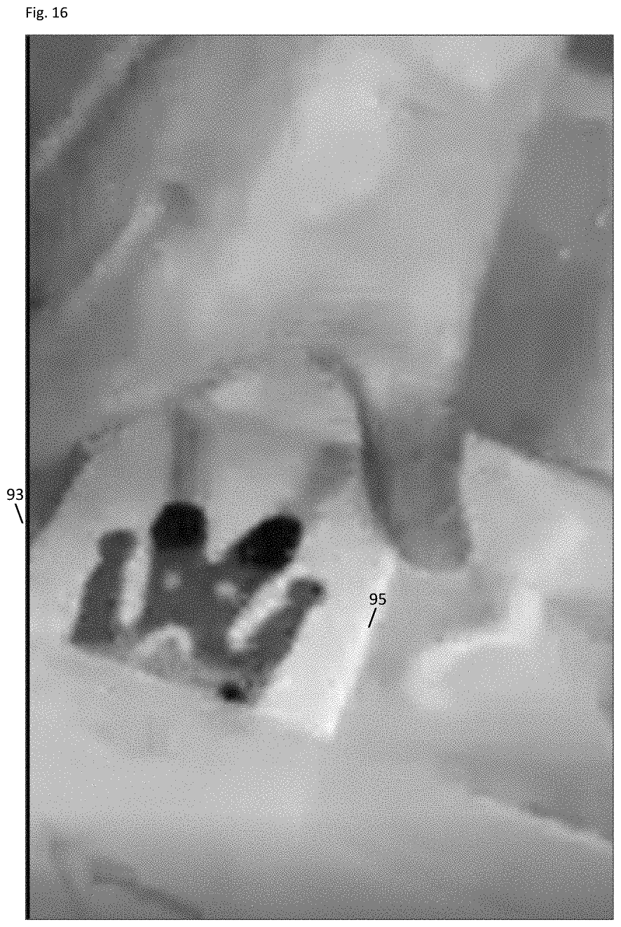

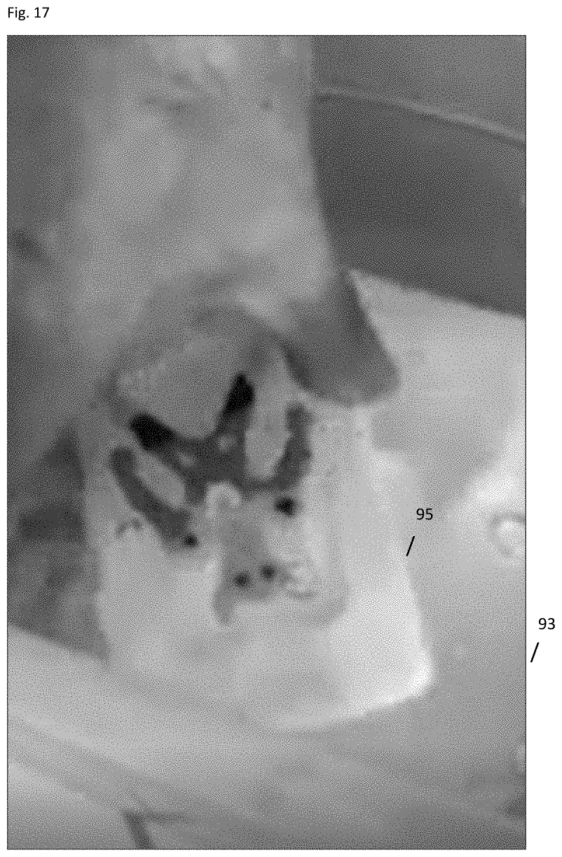

FIGS. 16-17: Depict the filled or completed mold of molded composition form 95 filled with various or multiple colored molding composition(s) (more than one) (or just one molding composition if desired) being immersed or submerged partially or completely into a tub of water 93 (can be any type of vessel, container beaker, pitcher, sink, bath tub, or other water or liquid holding device which has been filled with water or liquid and the powder portion of the invention (the curing agent or hardener) or filled with a pre-mixed mixture of water/liquid and the powder portion of the invention (the curing agent or hardener). In FIG. 17, the user is starting to gently jiggle or wiggle the mold to shake free the newly made creation from the mold.

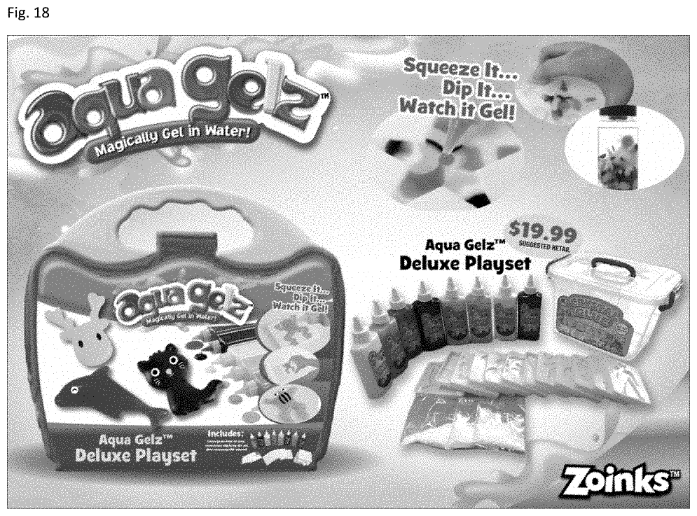

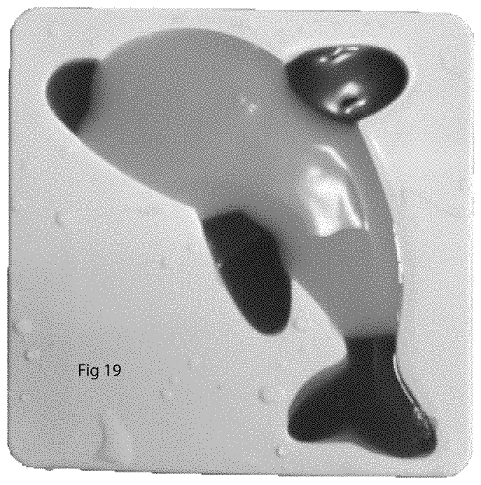

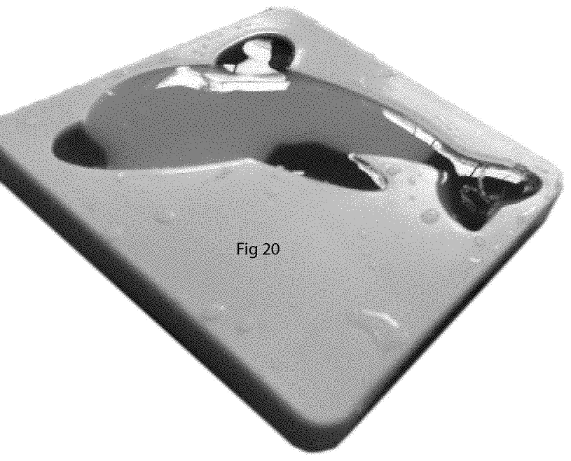

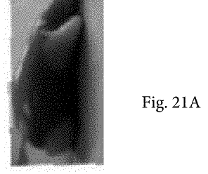

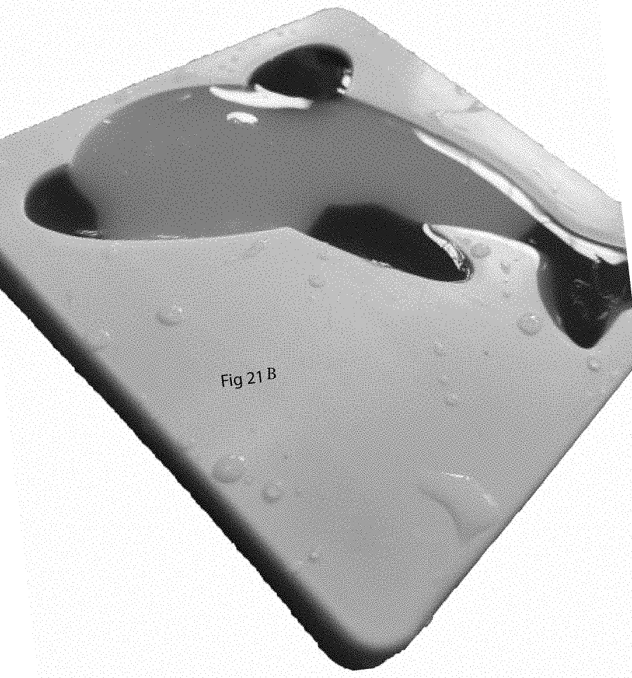

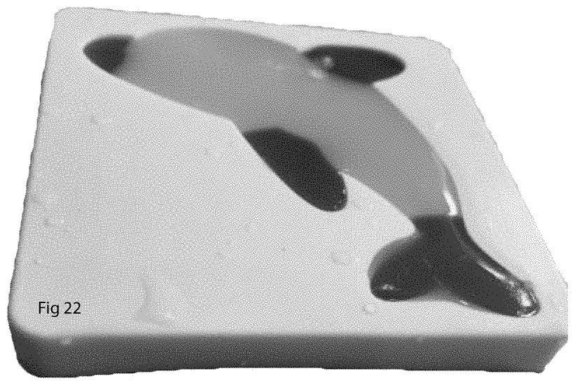

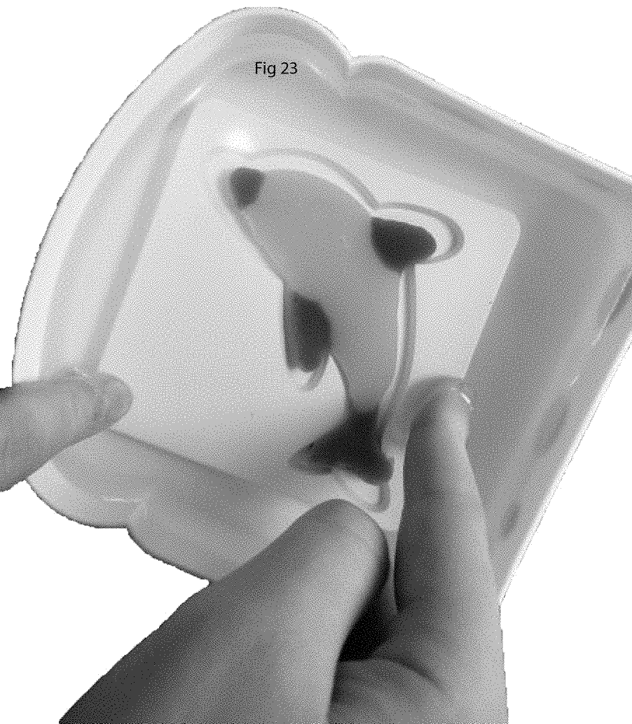

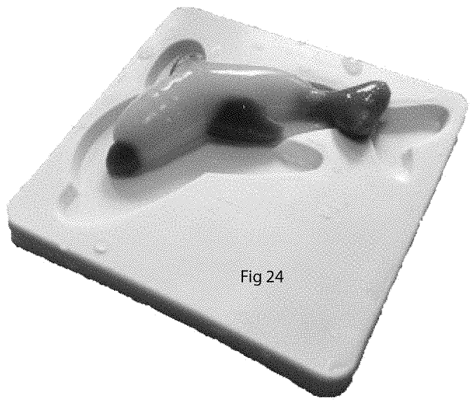

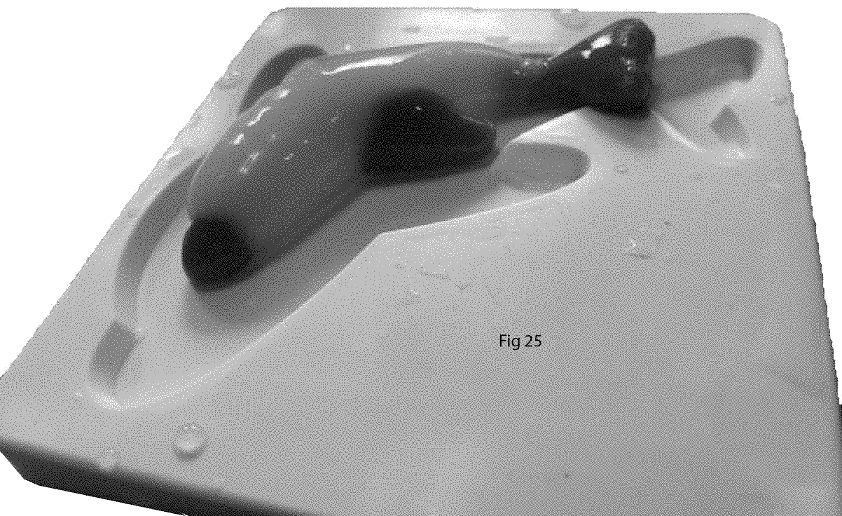

FIG. 18 depicts a marketing sheet for the commercial sale of the method of the present invention. It shows packaging, slogans, the commercial name of the invention “Aqua Gelz”, and information about the method: “Squeeze It, Dip It, Watch It Gel!” and “Magically Gel In Water!”.

In one embodiment, the method of the invention comprises:

adding or applying a molding composition (which can also include squeezing, pouring, dripping, etc., to some extent depending on the container the composition is in) (the composition can be a gel, or a viscous gel (for the definition of “gel” see the DEFINITIONS section of the DETAILED DESCRIPTION OF THE INVENTION section), it can be in different colors, textures, have sparkles, glitter, etc.) to a mold and/or molding surface;

providing a curing solution, (or first adding a curing activator/hardener to water to create a curing solution);

immersing the composition into the curing solution (immersing the composition and the mold and/or molding surface) (they can be immersed for a pre-determined amount of time, after only about a second, even less, the composition begins to cure and harden and shrink from the sides of the mold (the outer skin usually hardens and thickens first) to form a more solid smaller, plumper, rounder three-dimensional object);

curing the composition in the curing solution, this can also be done for a pre-determined amount of time (the longer the composition, or the now three-dimensional object, stays in the curing solution, the more cured and the harder it gets, it seems to thicken layer by layer from the outside in);

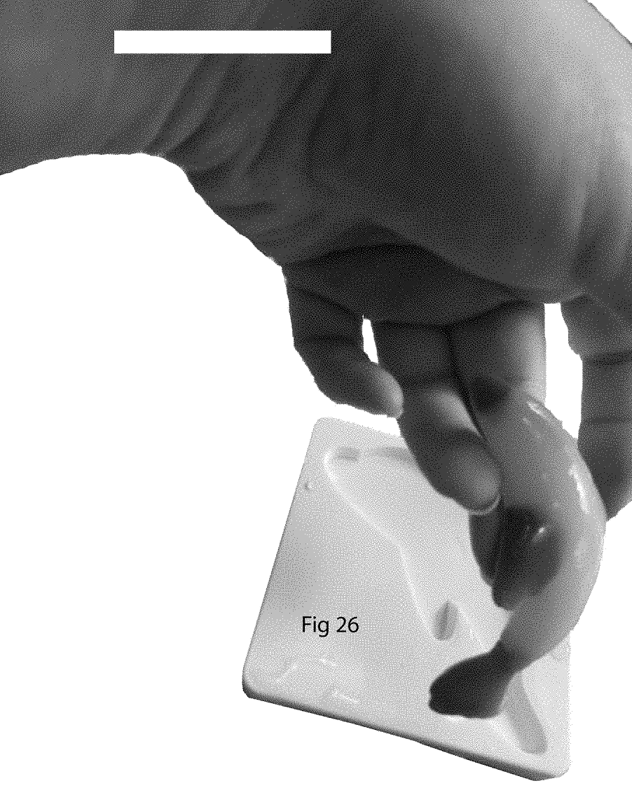

forming from the cured composition a three-dimensional object, well the three-dimensional object is actually being formed as soon as the composition hits the water, so this really refers to removing the three-dimensional object from the mold and/or molding surface, the object can be removed more quickly in the curing solution by shaking (usually gently shaking) the mold and/or molding surface, but the mold will usually release the object on its own without shaking; also, the object can then be removed from the curing solution and/or the mold and/or molding surface by lifting it out as shown in FIG. 26.

In another embodiment, the invention is a method of making a three-dimensional object or toy comprising:

applying a molding composition to a mold and/or molding surface to create a molded composition form;

providing a curing solution;

immersing the molded composition form into the curing solution together with the mold and/or molding surface;

curing the molded composition form in the curing solution;

removing a cured or partially cured molded composition form from the mold and/or molding surface, the toy being the cured or partially cured molded composition form. The toy being like a thickened gel with a solid skin or coating. Also, the toy is malleable, squeezable, and squishy.

In the method, the molding composition can be applied in various ways mostly depending upon the container it is in. For example, it can be squeezed out of a bottle or a tube, dripped or poured out of a container straight into a mold or onto a molding surface, or onto an implement such as a small scoop or spoon or stick that is used to place the molding composition into a mold or onto a molding surface.

In one embodiment of the inventive method, the molding composition comprises the following: water, at least one first thickener, at least one second thickener and at least one red dye.

Further, in this molding composition there can be:
80 to 99% water;
0.5 to 15% of the at least one first thickener;
0.05 to 10% of the at least one second thickener; and
0.005 to 0.10% of the at least one red dye.

Alternatively, in this molding composition there can be:
85 to 95% water;
1 to 5% of sodium alginate as the at least one first thickener;
0.95 to 1.5% of the at least one second thickener; and
0.005 to 0.05% of the at least one red dye, the at least one red dye being one of food
red 7, acid red 18, food red 102, red 27 and red 33.

Further, in this molding composition there can be:
the water having a tolerance of +1% and −X % of the mass of this component;
the sodium alginate having a tolerance of +/−X % of the mass of this component;
the at least one second thickener is cellulose, 2-hydroxypropyl methyl ether, with a tolerance of +/−X % of the mass of this component;
the at least on red dye is trisodium 1-(1naphthylazo)-2-hydroxynaphthalene-4′,6,8-trisulphonate), with a tolerance of +/−X % of the mass of this component.

In one embodiment of the inventive method, the curing solution comprises water and calcium chloride in the ratio of 1 gram of calcium chloride to Y milliliters of water. In this solution the amount of Y can vary, for example, Y=100+/−50 milliliters, Y=250+/−100 milliliters, etc.

In one embodiment of the inventive method, the curing solution comprises:
0.0 to 15% water; and
85 to 100% calcium chloride.

In another embodiment of the inventive method, the curing solution comprises:
1 to 3% water; and
95 to 99% calcium chloride.

In yet another embodiment of the inventive method, the curing solution comprises:

1 gram calcium chloride per 100 ml water=curing ratio, or

5 grams calcium chloride per 250 ml water.

The calcium chloride used in the curing solution in the invention can be in a powder form.

In one embodiment of the inventive method, the molding composition comprises at least one of the following: dye, glitter, sparkles, glow in the dark dye or material or pigment, florescent material, phosphorescent material, UV excitable material, at least one other additive or substance to alter the appearance or texture of the molding composition, and/or other additives for decorating.

In one embodiment, the inventive method further comprises, prior to the step of providing the curing solution, adding a curing agent to water and dispersing the curing agent in the water to create a curing solution.

In one embodiment, the inventive method further comprises, prior to the step of applying the molding composition, dipping the mold and/or molding surface in the curing solution; shaking any excess curing solution off the mold and/or molding surface and then applying the molding composition; and

further comprises, after applying the molding composition, tapping the mold and/or molding surface on another surface prior to immersing it into the curing solution.

In one embodiment, the inventive method further comprises, before or after the step of applying the molding composition, a step of adding to the mold and/or molding surface, or molding composition, at least one of a magnet, a magnetic disk, magnetic material and/or a special effects module.

In one embodiment, the inventive method further comprises, after the step of immersing, shaking the mold and/or molding surface to release, in whole or in part, the cured or partially cured molded composition form from the mold and/or molding surface.

In one embodiment, the inventive method further comprises, after the step of removing, leaving the toy immersed in the curing solution to cure for a longer period of time.

In one embodiment, the inventive method further comprises, after the step of removing, squeezing the toy to expel its contents in whole or in part.

In one embodiment, the invention comprises a molding composition comprising:
85 to 95% water, with a tolerance of +/−X % of the mass of this component; 1 to 5% of sodium alginate, with a tolerance of +/−X % of the mass of this component;
0.95 to 1.5% of hydroxypropylmethyl cellulose, with a tolerance of +/−X % of the mass of this component; and
0.005 to 0.05% of trisodium 1-(1naphthylazo)-2-hydroxynaphthalene-4′,6,8-trisulphonate, with a tolerance of +/−X % of the mass of this component.

In another embodiment, the invention comprises a molding kit for molding at least one toy comprising:

at least one molding composition, because the kit can come with different colors, or clear, or types (glitter, glow in the dark, etc.) of molding composition. At least one of the at least one molding compositions comprising water, at least one first thickener, at least one second thickener and at least one red dye, because the different molding compositions can be made of different components;

at least one curing agent, this curing agent can be placed in solution to create a curing solution to harden the molding composition; and

at least one mold and/or molding surface. The kit can also include magnets or magnetic parts or discs or special effects modules to include in the molded toy.

In another embodiment, the molding kit further comprises a first container for holding the curing agent in solution. Usually the curing agent is combined with water to make the curing solution, but other liquids might work as well.

In another embodiment, the molding kit further comprises a second container for holding the at least one toy after molding. Usually the completed toy is kept in a container of water without any added curing agent, except there may be some remaining curing agent on the toy itself. If the toy is left out of water, it will harden. In the water it will remain squishy.

In one embodiment of the invention, prior to applying the molding composition, you can rinse the mold/surface in curing solution, tap it to knock off excess liquid, fill it up with one or more molding compositions, tap the filled mold, and then the molded form begins to shrink away from the sides of the mold within seconds after being placed in curing solution, about 1 to about 2 seconds or fewer, sometimes about 3 or about 5 seconds. In some cases it might take as long as about 10 to about 30 seconds, when the newly forming 3-dimensional solid toy will begin to shrink away from the sides of the mold. Then it's time to shake or wiggle the mold side to side, preferably gently and preferably keeping the mold and the new toy at least partially or fully submerged in the water. Then the new toy will start to release itself (shrink away more) from the mold and float into the water. The new toy will have a thickened membrane at this point, but is likely still fragile and delicate to manipulate. It's the perfect state to go beyond the making of the toy to a method of using the toy. In this part of the invention, the toy can be used as a squishable, squirting toy to permanently expel, or, in other words, squirt out its insides (its inner, less hardened gel-like material) when it is squished or squeezed. An entire game can be made involving the making, squishing and squirting of these toys, in accordance with the present invention.

If the user does not desire to squish and squirt the newly created toy, then it can be left in the curing solution as long as desired to continue to cure/harden to reach the desired firmness. Then the firmer newly created toy can be played with, but it will still be malleable, squishy and thinner portions of it, like arms and legs, can be quite floppy. The method of the invention can then include placing the toy in fresh water to maintain the malleable, squishy and somewhat floppy characteristics, or it can be left out to air-dry where it will continue to harden and shrink until it is no longer as malleable, squishy or floppy.

In one embodiment of the invention, it is the method of chemical formation that produces a particular chemical reaction to form a toy and/or solid 3D object. More specifically when a gel component is mixed together with a second powder/liquid chemical formula mixture it results in 3d creations designed by users of this invention that are toys objects, things, figures, figurines, novelty and/or collectable objects.

One embodiment of the invention is a chemical composition, which elements when combined together react to form a three dimensional (3D) solid object designed by users to be used as toys, toy objects, shapes, things, characters, figures, figurines, play thing's, children's playthings, and/or novelty or collectable objects comprising:
a powder portion comprising:

| | | |
|---|---|---|
| 98% | CaCl 2 | Calcium Chloride |
| 2% | H2O | water |

which is distributed (poured into) into, mixed, into, and dissolved into a container, tub, and/or any type of vessel of water or other liquid;
and
a molding composition portion comprising:
   96% H2O Water (7732-18-5)
   3% (C₆H₇NaO₆)n or C₆H₉NaO₇ Sodium alginate
   (9005-38-3)
   0.99%
   C₃H₈O₂.xCH₄O. Cellulose, 2-hydroxypropyl methyl ether (9004-65-3)
   0.01%

C₂₀H₁₄N₂O₁₀S₃.3Na Formula:
Trisodium 1-(1-naphthylazo)-2-hydroxynaphthalene-4′,6,8-trisulphonate (2611-82-7)

which is immersed or submerged into the container, tub, and/or any type of vessel of water or other liquid having the powdered portion dissolved therein to react to form a 3D solid object designed by users to be used as toys, toy objects, shapes, things, play things, characters, figures, figurines, and/or novelty or collectable objects.

In another embodiment, the invention is a method of designing and creating a three dimensional (3D) solid (or hardened gel, flexible solid, gummy solid, or soft solid) object toy, toy object, 3d shape, thing, character, figure, figurine, and/or novelty or collectable object comprising of the following steps:

dispensing at least one colored or transparent gel comprising of the following chemical formula composition:
96% H2O Water (7732-18-5)
3% (C₆H₇NaO₆)n or C₆H₈NaO₇ Sodium alginate (9005-38-3)
0.99% C₃H₈O₂.xCH₄O. Cellulose, 2-hydroxypropyl methyl ether (9004-65-3)
0.01%

C₂₀H₁₄N₂O₁₀S₃.3Na Formula:
Trisodium 1-(1-naphthylazo)-2-hydroxynaphthalene-4′,6,8-trisulphonate (2611-82-7)

into or on to a mold or other portable surface or surface device capable of holding or placing theron the disbursed or dispensed gel or gels;

and

dispensing into, emptying into, or pouring into and dissolving and/or stirring into a container, tub, and/or any type of vessel of water or other liquid a powder chemical composition of:

| | | |
|---|---|---|
| 98% | CaCl 2 | Calcium Chloride |
| 2% | H2O | water |

and

submerging, placing, or immersing the mold or surface with gel(s) into the container, tub, and/or any type of vessel of water or other liquid that contains the dissolved powder chemical composition;

and

once the gel(s) is submerged, immersed, placed then the gel(s) immediately reacts with the water or other liquid containing the powder chemical composition creating a 3D solid object toy, toy object, 3d shape, thing, character, figure, figurine, and/or novelty or collectable object.

The at least one gel can have the following predominant composition of components: 96% H₂O (or water), with a tolerance of +1% and −X % of the mass of this component;

3% (C₆H₇NaO₆)n or C₆H₉NaO₇ (or sodium alginate), with a tolerance of +/−X % of the mass of this component;

0.99% C₃H₈O₂.CH₄O (or cellulose, 2-hydroxypropyl methyl ether), with a tolerance of +/−X % of the mass of this component;

0.01% C₂₀H₁₄N₂O₁₀S₃.3Na (or trisodium 1-(1naphthylazo)-2-hydroxynaphthalene-4′,6,8-trisulphonate), with a tolerance of +/−X % of the mass of this component.

The sum of said components within their tolerances equaling the whole without substantively affecting the behavior of said at least one gel.

In one embodiment the above tolerance can have a value of X=5, thus producing a tolerance of 5%.

In one embodiment the above tolerance can have a value of X=10, thus producing a tolerance of 10%.

The gel can further comprise at least one dye and/or pigment to create a gel of a particular color.

The gel can further comprise at least one of glitter, glow in the dark dye or material or pigment, florescent material, phosphorescent material, UV excitable material, or at least one other additive substance to alter the appearance of the gel.

At least one hardening agent can have the predominant composition of CaCl₂ (or calcium chloride) in the form of a powder. The hardening agent is mixed with H₂O (or water) in the form of tap water or externally available water to produce a mixture. This mixture can be composed in the ratio of 1 gram of CaCl₂ (or calcium chloride) to Y milliliters of water where Y can have a value of 100+/−50 milliliters. Y can also have a value of 250+/−100 milliliters.

At least one hardening agent can have the predominant composition of between 100% CaCl₂ (or calcium chloride) and 0% H₂O (or water) to 85% CaCl₂ (or calcium chloride) and 15% H₂O (or water).

At least one hardening agent can have the predominant composition of 98% CaCl₂ (or calcium chloride) and 2% H₂O (or water).

Other thickeners besides sodium alginate and cellulose, 2-hydroxypropyl methyl ether include, but are not limited to sodium hexametaphosphate and oxidized tapioca. The first thickener and the second thickener can be the same.

One embodiment of the inventive method further comprises imbedding a magnet or a magnetic material within said figurine or three-dimensional object to enable said figurine or three-dimensional object to attach magnetically to a pin or broach containing a complimentary magnet or magnetic material, said pin or broach having the capability of being pinned or attached to clothing while being worn, thus creating a wearable user-creatable figurine or three-dimensional object.

In another embodiment, the inventive method further comprises imbedding within said figurine or three-dimensional object at least one of a magnet, a magnetic disk, a special effects module.

Then, the method can include steps further comprising:

placing said figurine or three-dimensional object against a magnetic receiving element like a pin or broach to form a piece of wearable art;

and/or

activating said special effects module to execute at least one special effect, for example by pressing an “on” button, or activating it by remote control, or using a module that turns on in response to sound or contact with another surface with sufficient force.

When the three-dimensional object has a magnet, a magnetic disk, magnetized metal, or other material embedded in it that responds to a magnet and the method further comprises passing a magnet in close proximity to the figurine or three-dimensional object, this will result in moving or tilting or causing motion in the figurine or three-dimensional object, at least at the location of the magnet, magnetic disk, magnetized metal, or other material embedded in it that responds to a magnet.

Another embodiment of the inventive method further comprises imbedding a special effects module powered by at least one battery within said figurine or three-dimensional object, said special effects module comprising the ability to do at least the following:
generate at least one LED output in at least one pattern;
generate at least one audio output in at least one pattern;
communicate wirelessly.

One embodiment of the invention comprises a powder portion comprising:
98% CaCl₂ (or calcium chloride)
2% H₂O (or water);

and

a gel portion comprising:
96% H₂O or water
3% (C₆H₇NaO₆)n or C₆H₉NaO₇ (or sodium alginate)
0.99% C₃H₈O₂.CH₄O (or cellulose, 2-hydroxypropyl methyl ether)
0.01% C₂₀H₁₄N₂O₁₀S₃.3Na
   (or trisodium 1-(1naphthylazo)-2-hydroxynaphthalene-4′,6,8-trisulphonate).

One embodiment of the method uses the molding composition to create a mold, specifically a model from which can be made a negative mold, also using the molding composition, and then that negative mold can be used to make another model, or positive mold. In other words, it's a method of creating a duplicate three-dimensional object and it can comprise the following steps:

(a.) dispense at least one molding composition over a first positive three-dimensional object, layer by layer to construct a negative mold;

(b.) place the three-dimensional object/model (with the new layer(s) of molding composition thereon) in a pre-mixed hardening agent mixture (curing solution) to harden;

(c.) repeat steps (a.) and (b.) as many times as necessary to build up sufficient wall thickness of applied gel to provide sufficient mechanical rigidity for the steps to follow;

(d.) cut the hardened layers of gel off the three-dimensional object (using a tool like a butter knife) to create a negative top half mold and a negative bottom half mold, or a negative right side mold and a negative left side mold, or whatever works to remove the negative mold from the positive mold so that the negative mold can be used to make another, a second (duplicate) positive mold (a model/duplicate three-dimensional object), the negative mold does not have to be separated exactly in half, it could be about 0.75 on one side and about 0.25 on another, or three pieces in thirds, whatever works;

(e.) apply a lubricating substance to the inside of both negative parts or halves of the mold such as soap, baby oil or Vaseline®;

(f.) create a second (duplicate) positive three-dimensional object by dispensing at least one molding composition in each part of the negative mold, e.g., into the negative top half mold to create a top half positive and dispense at least one molding composition in the negative bottom half mold to create a bottom half positive;

(g.) place each part of the filled negative mold into the curing solution, e.g., place the negative top half mold filed with molding composition and the negative bottom half mold filled with molding composition into the hardening agent mixture to harden;

(h.) after sufficient hardening time, remove each part of the new three-dimensional positive model, e.g., remove the top half positive and the bottom half positive;

(i.) apply molding composition to the parts of the new three-dimensional positive model at the junctures where they join other parts of the new three-dimensional positive model, e.g., apply molding composition to the top half positive and the bottom half positive at the interface between the two and place them together to attach or glue them;

(j.) place this glued-together positive three-dimensional object into the hardening agent mixture (the curing solution);

(k.) remove the new duplicate three-dimensional object and trim excess gel as needed.

Whichever type of container is used for the molding composition (whose which includes compositions that are clear or which have color, usually from dye), it is useful for the container to have a cap that can assist in the dispensing of the molding composition into the mold or onto the molding surface. For example, the cap 5 of squeeze bottle 1A can be twisted open and shut and has a small opening in the top for squeezing out the molding composition, like a bottle of Elmer's° glue. In this way, the placement of the molding compositon is easily directed by the user squeezing out the molding composition from the small opening. On the other hand, if the opening were like a soda bottle, the contents would just come pouring right out and it would be more difficult for the user to direct the placement of the molding composition in the mold.

In one embodiment, the invention is a method of creating a figurine or three-dimensional object comprising the following steps
(a.) dispensing at least one gel, as the molding composition in this example, within a
mold or placing it upon an area of a surface wherein said dispensing is:

dispensing a single gel to fill the entire mold or be placed upon an area of a surface;

or

dispensing a first gel filling a first area of said mold or area of a surface and a second gel filling a second area of said mold or area of a surface and repeating this step any number of times with any number of gels filling any number of areas within said mold or areas of a surface,

or

dispensing any number of gels filling any number of areas within said mold or area of a surface and dispensing any other number of gels over already applied gels to form at least one or more layer or layers of gels filling said mold or being applied to an area of a surface;

(b.) mixing a hardening agent with water to create a hardening mixture within a container large enough to contain the entire mold (noting that steps a. and b. can be reversed or performed at the same time);

(c.) placing the mold or molding surface with the molding composition in said container containing said hardening mixture;

(d.) after sufficient time removing the cured molded figurine or three-dimensional object from the hardening mixture for display or for playing with.

In one embodiment, the invention comprises a molding toy to produce a figurine or three-dimensional object comprising:
at least one gel, as an example of the molding composition;
at least one mold in which said at least one gel is placed within to form a figurine or three-dimensional object;
at least one hardening agent mixed with water to produce a mixture in which is placed said at least one gel or said at least one mold containing said at least one gel, and after sufficient curing time said figurine or three-dimensional object is removed and can be displayed or played with as a toy.
In one embodiment, the composition is a gel, as defined herein. A fun aspect of the invention is that it enables the user to create a user-creatable figurine with a three-dimensional shape. When a traditional mold is used, the composition or gel is dispensed or applied within the depression of the mold to create at least one surface of the three-dimensional shape. A molding surface can also be used in the invention. The hardening or curing agent is the component that cures the composition, which can be a gel, within (or on) the mold, to the point where the composition can be removed from the mold. Once removed from the mold, the composition can continue to cure as a function of exposure time within the curing agent.
The greater the concentration of the curing agent, the faster the three-dimensional object will cure. The curing time will also depend upon the surface area and volume of the three-dimensional object. As the surface area to volume ratio increases, the curing time decreases, and the greater the distance to the center of the three-dimensional shape, the greater will be the total curing time. For kids, the inventive method also uses molds that are wide and flat (i.e., shallow depressions), so that curing time is short enough to make the invention fun for children to use and get instant gratification as they make and play with the shapes they create.

In one embodiment of the inventive method, the composition is provided in one or more squeeze bottles that can be dispensed into molds or forms, or onto surfaces (molding surfaces) that can define at least one surface of a three-dimensional object. The composition is available in a variety of colors, or colorless, and textures, and some contain sparkles, etc. One color can be dispensed from one bottle at a time by turning the bottle upside down and squeezing the composition into the mold. In this way a three-dimensional object can be created as the mold is filled either completely by one color molding composition or by dispensing multiple colors to create patterns only limited by the user's imagination. The mold can form virtually any shape, and the compositions and/or gels can be squeezed in any pattern within the mold.

One embodiment of the invention is a method of creating a figurine or three-dimensional object comprising the following steps
(a.) dispensing at least one gel, as a molding composition, within a mold or placing upon an area of a surface wherein said dispensing is:
   dispensing a single gel to fill the entire mold or be placed upon an area of a surface;
   or
   dispensing a first gel filling a first area of said mold or area of a surface and a second gel filling a second area of said mold or area of a surface and repeating this step any number of times with any number of gels filling any number of areas within said mold or areas of a surface,
   or
   dispensing any number of gels filling any number of areas within said mold or area of a surface and dispensing any other number of gels over already applied gels to form at least one or more layer or layers of gels filling said mold or being applied to an area of a surface;
(b.) mixing a hardening agent with water to create a hardening mixture (curing solution) within a container large enough to contain an entire mold (noting that steps a. and b. can be reversed or performed at the same time);
(c.) placing the mold containing the figurine or three-dimensional object within the container containing the hardening mixture or causing said figurine or three-dimensional object formed upon said area of a surface to be placed within said container containing said hardening mixture;
(d.) after sufficient time removing said figurine or three-dimensional object from said hardening mixture for display or for playing with.

When the mold is filled, the entire mold can be immersed in the curing solution which is generally a substantially liquid solution. One example of the curing solution is a mixture of a salt and water, though is not limited to a salt and water, where the salt acts as the curing agent. The curing agent or hardener can also be a liquid, like the water. An example of one salt that works well is calcium chloride. However, other salts should also work, like sodium chloride, potassium chloride, sodium bisulfate, potassium dichromate, etc.

An example of a curing solution useful in the present invention is about 1 gram of salt to about 100 milliliters of water, or comparable liquid (herein referred to as “water”). While this is a good ratio, the invention is not limited to this ratio and other ratios work. As stated, the greater the concentration the shorter the curing time. Exemplary ranges useful in the present invention also include about 0.5 to about 1.5 grams of salt to about 50 to about 150 mililiters of water, or 0.25 to about 0.75 grams of salt to about 25 to about 75 mililiters of water, or 0.5 to about 1.5 grams of salt to about 50 to about 150 mililiters of water, 0.15 to about 1.5 grams of salt to about 15 to about 150 mililiters of water, or 0.15 to about 2.5 grams of salt to about 15 to about 250 mililiters of water, with varying concentrations of salt possible depending on the desired curing time.

The molding compositions or gels can be different colors, can be glow in the dark formulations, can contain glitter, or can have other shapes or solid or soft objects imbedded within any composition.

In one embodiment molds can be filled using gels, though it is possible to draw in a free form manner by dispensing a gel, or other molding composition, from the bottle onto a surface. You can write your name or deposit gel layer by layer onto a surface. In this free form manner, a user can build or sculpt a three-dimensional object for subsequent curing.

A user can use the molding composition to make a soft mold (a negative) of a three-dimensional object or original shape, whether the original is made of the molding composition or not. When this mold or negative is made, the mold can be used to make a positive form by dispensing the molding composition into the negative mold created from the original shape, and in this manner, a duplicate or near-duplicate of the original shape can be made from the molding composition.

The curing solution can be prepared before or after applying the molding composition by dissolving, mixing the crystal solution. It is possible to use more of the hardener/curing agent if warranted. Then, it's a good idea to gently submerge the filled mold in the curing solution, after a few seconds, start to gently wiggle it, shake it from, side to side, and it will start to release, shrink away from the mold, a little later usually about 5 to about 120 seconds, about 10 to about 60 seconds, about 10 to about 40 seconds, about 10 to about 30 seconds, about 15 to about 30 seconds later, etc. The method further comprises re-using the curing solution to submerge another filled mold; and wherein the method further comprises dipping the mold and/or molding surface in the curing solution prior to applying the molding composition (which can include glow in the dark colors, solid colors, translucent colors, etc.); and the method can further comprise adding another layer of molding composition on top of molding composition previously filled in the mold; and the method can further comprise tapping the filled mold and/or molding surface on another surface prior to placing, immersing, dipping it into the curing solution; and the method can further comprise dipping the mold and/or molding surface into the curing solution prior to filling it and/or dispensing molding composition, removing the mold and/or molding surface, shaking the mold and/or molding surface to remove any excess solution, tapping the mold and/or molding surface against another surface to remove any excess solution, and then filling the mold with the molding composition.

While the instant invention has been shown and described in accordance with preferred and practical embodiments thereof, it is recognized that departures from the instant disclosure are contemplated to be within the spirit and scope of the present invention. Therefore, the true scope of the invention should not be limited since other modifications will become apparent to those skilled in the art upon a study of the claims, drawings, descriptions, explanations, and specifications herein. It is understood that various changes and modifications can be made within the spirit and scope of the present invention.

Those skilled in the art will appreciate that the conception, upon which this disclosure is based, may readily be utilized as a basis for the designing of other methods and compositions for carrying out the present invention. It is therefore important that the claims be regarded as including such equivalent constructions insofar as they do not depart from the spirit and scope of the present invention. The abstract is neither intended to define the invention of the instant application, which is measured by the claims, nor is it intended to be limiting as to the scope of the invention in anyway.

What is claimed is:

1. A method of making a three-dimensional object comprising:
applying at least one molding composition to a mold and/or molding surface to create a molded composition form;
providing a curing solution;
immersing the molded composition form into the curing solution together with the mold and/or molding surface;
curing the molded composition form in the curing solution;
removing a cured or partially cured molded composition form from the mold and/or molding surface, the three-dimensional object being the cured or partially cured molded composition form.

2. The method of claim 1, wherein the step of applying the molding composition comprises at least one of squeezing the molding composition out of a bottle or a tube, dripping the molding composition out of a container, and/or pouring the molding composition out of a container.

3. The method of claim 1, wherein the molding composition comprises the following: water, at least one first thickener, at least one second thickener and at least one red dye.

4. The method of claim 3, wherein the molding composition comprises the following:
80 to 99% water;
0.5 to 15% of the at least one first thickener;
0.05 to 10% of the at least one second thickener; and
0.005 to 0.10% of the at least one red dye.

5. The method of claim 4, wherein the molding composition comprises the following:
85 to 95% water;
1 to 5% of sodium alginate as the at least one first thickener;
0.95 to 1.5% of the at least one second thickener; and
0.005 to 0.05% of the at least one red dye, the at least one red dye being one of food red 7, acid red 18, food red 102, red 27 and red 33.

6. The method of claim 5, wherein:
the water has a tolerance of +1% and −X % of the mass of this component;
the sodium alginate has a tolerance of +/−X % of the mass of this component;
the at least one second thickener is cellulose, 2-hydroxypropyl methyl ether, with a tolerance of +/−X % of the mass of this component;
The at least on red dye is trisodium 1-(1naphthylazo)-2-hydroxynaphthalene-4′,6,8-trisulphonate), with a tolerance of +/−X % of the mass of this component.

7. The method of claim 1, wherein the curing solution comprises water and calcium chloride in the ratio of 1 gram of calcium chloride to Y milliliters of water.

8. The method of claim 7, wherein Y=100+/−50 milliliters.

9. The method of claim 7, wherein Y=250+/−100 milliliters.

10. The method of claim 1, wherein the curing solution comprises:
0.0 to 15% water; and
85 to 100% calcium chloride.

11. The method of claim 1, wherein the curing solution comprises:
1 to 3% water; and
95 to 99% calcium chloride.

12. The method of claim 1, wherein the molding composition comprises at least one of the following: dye, glitter, sparkles, glow in the dark dye or material or pigment, florescent material, phosphorescent material, UV excitable material, at least one other additive or substance to alter the appearance or texture of the molding composition, and/or other additives for decorating.

13. The method of claim 1, further comprising, prior to the step of providing the curing solution, adding a curing agent to water and dispersing the curing agent in the water to create a curing solution.

14. The method of claim 1, further comprising, prior to the step of applying the molding composition, dipping the mold and/or molding surface in the curing solution; shaking any excess curing solution off the mold and/or molding surface and then applying the molding composition; and
further comprising, after applying the molding composition, tapping the mold and/or molding surface on another surface prior to immersing it into the curing solution.

15. The method of claim 1, further comprising, before or after the step of applying the molding composition, a step of adding to the mold and/or molding surface, or molding composition, at least one of a magnet, a magnetic disk, magnetic material and/or a special effects module.

16. The method of claim 1, further comprising, after the step of immersing, shaking the mold and/or molding surface to release, in whole or in part, the cured or partially cured molded composition form from the mold and/or molding surface.

17. A molding composition comprising:
85 to 95% water, with a tolerance of +/−X % of the mass of this component;
1 to 5% of sodium alginate, with a tolerance of +/−X % of the mass of this component;
0.95 to 1.5% of hydroxypropylmethyl cellulose, with a tolerance of +/−X % of the mass of this component; and
0.005 to 0.05% of trisodium 1-(1naphthylazo)-2-hydroxynaphthalene-4′,6,8-trisulphonate, with a tolerance of +/−X % of the mass of this component.

18. A molding kit for molding at least one three-dimensional object comprising:
at least one molding composition, at least one of the at least one molding compositions comprising water, at least one first thickener, at least one second thickener and at least one red dye;
at least one curing agent; and
at least one mold and/or molding surface.

19. The molding kit of claim 18, further comprising a first container for holding the curing agent in solution.

20. The molding kit of claim 18, further comprising a second container for holding the at least one three-dimensional object after molding.
